(19) United States
(12) Patent Application Publication
(10) Pub. No.: US 2025/0233156 A1
(43) Pub. Date: Jul. 17, 2025

(54) SECONDARY BATTERY, ELECTRONIC DEVICE, AND METHOD FOR PREPARING SECONDARY BATTERY

(71) Applicant: Ningde Amperex Technology Limited, Ningde (CN)

(72) Inventor: Ao LIU, Ningde (CN)

(73) Assignee: Ningde Amperex Technology Limited, Ningde (CN)

(21) Appl. No.: 19/060,072

(22) Filed: Feb. 21, 2025

Related U.S. Application Data
(63) Continuation of application No. PCT/CN2022/114270, filed on Aug. 23, 2022.

(51) Int. Cl. H01M 4/62; H01M 4/02; H01M 4/04; H01M 4/131; H01M 4/133; H01M 4/134; H01M 4/36; H01M 4/38; H01M 4/587

(52) U.S. Cl. CPC H01M 4/628; H01M 4/0404; H01M 4/0471; H01M 4/131; H01M 4/133; H01M 4/134; H01M 4/364; H01M 4/386; H01M 4/587; H01M 2004/021; H01M 2004/027

(57) ABSTRACT

An electrode assembly of a secondary battery includes an anode electrode plate, the anode electrode plate includes an anode current collector and an anode active material layer, and the anode active material layer includes an anode active material. A first surface of the anode active material layer has been subjected to a lithium supplementing process treatment, and an active lithium is formed during a formation process of the anode electrode plate. A recessed portion provided in the first surface can serve as a lithium-ion transport channel.

### CROSS REFERENCE TO RELATED APPLICATION

This application is a continuation application of International Application No. PCT/CN2022/114270, filed on Aug. 23, 2022, the contents of which are incorporated herein by reference in its entirety.

### TECHNICAL FIELD

This application relates to the field of energy storage technologies, particularly to a secondary battery, an electronic device, and a method for preparing a secondary battery.

### BACKGROUND

Secondary batteries refer to batteries that can be used continuously, after battery charge, by charging to activate active materials. Secondary batteries are widely used in electronic devices such as mobile phones and laptop computers.

In the development of battery technology, lithium-ion batteries are widely used due to their advantages such as high output power, long cycle life, and low environmental pollution. How to improve the processing performance of secondary batteries and achieve better performance has always been a research direction for personnel in the field of energy storage technology.

### SUMMARY

This application provides a secondary battery, an electronic device, and a method for preparing a secondary battery. The secondary battery can improve the discharge performance while shortening the processing time, helping to improve the processing efficiency.

According to a first aspect, this application provides a secondary battery including an electrode assembly, where the electrode assembly includes an anode electrode plate, the anode electrode plate includes an anode current collector and an anode active material layer provided on the anode current collector, and the anode active material layer includes an anode active material; and the anode active material layer has a first surface facing away from the anode current collector, the anode active material layer is provided with a recessed portion recessed from the first surface towards the anode current collector, and the first surface has been subjected to a lithium supplementing process treatment.

Because the first surface of the anode active material layer has been subjected to the lithium supplementing process treatment, active lithium is formed during the formation of the anode electrode plate to compensate for an irreversible capacity loss of a first charge-discharge cycle, helping to improve the first coulombic efficiency and capacity retention rate of the battery, thereby improving the discharge performance of the battery. The recessed portion penetrating the first surface can serve as a lithium-ion transport channel, which not only increases the diffusion speed of lithium ions, helping to shorten the standing lithium supplement time and reduce side reactions generated during standing lithium supplementation, but also alleviates the problem of uneven lithium ion concentration in the thickness direction of the anode active material layer, accelerating the internal reaction of the anode active material layer and allowing for a more sufficient reaction of the lithium supplementing material.

In an embodiment of this application, the recessed portion includes a hole and/or a groove. The recessed portion includes a hole, allowing for accurate positioning of the recessed portion during processing and helping precise control of the recessed portion. The recessed portion includes a groove, allowing for continuous processing of the recessed portion and helping to improve the processing efficiency of the recessed portion.

In an embodiment provided in this application, the anode active material layer is provided with a plurality of the recessed portions, the radius of the recessed portion is R μm, the depth of the recessed portion is H μm, and the distance between two adjacent recessed portions is L μm, A=L/(R×H) is defined, and 0.20≤A≤5.00. The parameter A of the recessed portion being greater than or equal to 0.2 and less than or equal to 5 facilitates processing of the recessed portion and allows the recessed portion to have a sufficient lithium-ion diffusion capability.

In an embodiment provided in this application, 0.20≤A≤3.50, helping to further improve the lithium-ion diffusion capability of the recessed portion.

In an embodiment provided in this application, the radius of the recessed portion is R μm, and 10≤R≤50. The recessed portion within this size range serves as a lithium- ion transport channel. This can improve the lithium-ion transport efficiency, shorten the standing lithium supplement time, and reduce the impact of the recessed portion on the first surface, thereby maintaining the original morphology of the first surface and reducing the adverse impact on the electrochemical performance of the anode active material layer.

In an embodiment provided in this application, 30≤R≤50, which can further improve the lithium-ion transport efficiency on the basis of reducing the impact of the recessed portion on the first surface and maintaining the original morphology of the first surface, allowing for a more significant effect of shortening the standing lithium supplement time.

In an embodiment provided in this application, the depth of the recessed portion is H μm, and 8≤H≤30, such that the recessed portion can effectively diffuse ions and also reduce the impact on the adhesion of the anode active material layer, reducing the possibility of the anode active material layer falling off the anode current collector.

In an embodiment provided by this application, 15≤H≤30, such that the recessed portion minimizes the impact on the adhesion of the anode active material layer and effectively diffuses ions.

In an embodiment provided by this application, the anode active material layer is provided with a plurality of the recessed portions, the distance between two adjacent recessed portions is L μm, and 50≤L≤300, allowing the plurality of the recessed portions to have a sufficient lithium-ion diffusion capability, such that the lithium ions generated by the lithium supplementing process on the first surface of the anode active material layer can diffuse quickly and thoroughly into the anode active material layer.

In an embodiment provided in this application, 50≤L≤150, and the distribution interval between the plurality of the recessed portions in the anode active material layer is within a preset range, further allowing the plurality of the recessed portions to have a sufficient lithium-ion diffusion capability.

In an embodiment provided in this application, the anode active material layer has a stripe portion exposed from the first surface and extending in a first direction. In the direction perpendicular to the extension direction of the stripe portion, the width of the stripe portion is 0.1 mm to 2.0 mm, and this width range facilitates the processing of a metal lithium foil during the lithium supplementing process, helping to reduce the processing difficulty by processing the metal lithium foil into the stripe portion; and/or the thickness of the stripe portion is 0.04 μm to 0.50 μm, and this thickness range is controlled based on the side reactions of metal lithium during the lithium supplementing process.

In an embodiment provided in this application, the anode active material layer further includes a lithium compound exposed from the first surface, and the lithium compound includes one or more of lithium carbonate and lithium oxide. The lithium compound on the first surface helps to increase the surface resistance of the anode electrode plate, reduce the short-circuit current of the secondary battery, and lower the risk of thermal runaway caused by short circuit of the anode electrode plate.

In an embodiment provided in this application, the anode electrode plate further includes a conductive layer disposed on the first surface, and the conductive layer includes a conductive agent and a binder. Disposing the conductive layer on the first surface of the anode active material layer helps to improve the conduction capability of the anode active material layer and accelerate the entry of lithium ions into the anode active material during the lithium supplementing, thereby improving the lithium supplementing efficiency.

In an embodiment provided by this application, the thickness of the conductive layer is B μm, and 0.5≤B≤8.0, allowing the conductive layer to have good conduction capability and reducing the thickness of the anode electrode plate occupied by the conductive layer.

In an embodiment provided in this application, the porosity of the conductive layer is C, and 30%≤C≤60%, making the conductive layer a porous structure, and helping to improve the conduction capability of the conductive layer.

In an embodiment provided in this application, the recessed portion is formed through a laser processing process, and the laser processing process can remove the material of the anode active material layer to form the recessed portion, providing a good effect of the recessed portion on ion diffusion.

In an embodiment provided by this application, the cross section of the recessed portion is V-shaped, meaning that the recessed portion is conical, and the area of the opening of the recessed portion in the first surface is greater than the area of the bottom of the recessed portion. This shape of the recessed portion facilitates processing and reduces processing difficulty, helping to improve the processing efficiency of the recessed portion.

In an embodiment provided by this application, a height of an edge portion of the recessed portion protruding out of the first surface is h μm, and 3≤h≤10. This not only increases the diffusion area of the diffusion channel, helping to improve the lithium ion diffusion effect of the recessed portion, but also increases the contact area between the anode active material layer and the electrolyte for reaction, helping to increase the sites of reaction between the anode active material layer and the electrolyte and improve the discharge rate performance of the secondary battery. In addition, h is not excessively large, such that the interface contact between the cathode and anode electrode plates is not affected.

In an embodiment provided in this application, the anode active material includes one or more selected from the group consisting of a carbon material, a silicon materialand a tin material. These materials have stable chemical properties, are corrosion-resistant, acid and alkali-resistant, and have good conductivity, helping to improve the electrochemical performance of the anode electrode plate.

In an embodiment provided in this application, the electrode assembly further includes a cathode electrode plate and a separator, and the cathode electrode plate, the separator, and the anode electrode plate are stacked, with the first surface in contact with the separator. The separator can isolate the anode electrode plate from the cathode electrode plate to prevent short circuit due to contact between the cathode electrode plate and the anode electrode plate. This helps the separator to directly transfer the electrolyte into the anode electrode plate via the recessed portions and also helps the lithium ions de-intercalating from the cathode to pass through the separator and directly enter the anode active material layer via the recessed portions.

According to a second aspect, this application provides an electronic device including the secondary battery provided by any of the above technical solutions.

According to a third aspect, this application provides a method for preparing a secondary battery. This method includes: preparing an anode slurry from an anode active material and an anode binder at a preset ratio; applying the anode slurry to an anode current collector to form an anode active material layer, thus obtaining an anode electrode plate; forming a recessed portion in the anode active material layer, where the anode active material layer has a first surface facing away from the anode current collector, and the recessed portion penetrates the first surface; disposing a lithium supplementing material on the first surface; assembling the anode electrode plate into an electrode assembly; assembling the electrode assembly to obtain a secondary battery; and performing formation process in the secondary battery. Through the above method for preparing the secondary battery, a secondary battery including an anode electrode plate that contains a lithium supplementing material and has a recessed portion can be obtained. This secondary battery not only can reduce the impedance of the electrode plate and has good discharge performance, but also can shorten the processing time, helping to improve the processing efficiency.

In an embodiment provided in this application, the lithium supplementing material is lithium foil, and the lithium foil is disposed on the first surface and subjected to a rolling process. This helps to improve the manufacturing efficiency of the lithium supplementing process and reduce the side reactions between the lithium supplementing material and environmental factors during the lithium supplementing.

In an embodiment provided in this application, the recessed portion is formed in the anode active material layer through a laser processing process. The energy provided by laser can be used to remove the anode active material and binder from the anode active material layer and has a small impact on the material accumulation state of the anode active material layer.

### BRIEF DESCRIPTION OF DRAWINGS

To describe the technical solutions in some embodiments of this application more clearly, the following briefly describes the accompanying drawings required for describing these embodiments of this application. Apparently, the accompanying drawings in the following description show merely some embodiments of this application, and persons of ordinary skill in the art may still derive other drawings from the accompanying drawings.

FIG. 1 is a schematic structural diagram of an electrode assembly according to some embodiments of this application;

FIG. 2 is a schematic structural diagram of an anode electrode plate according to some embodiments of this application;

FIG. 3 is a schematic structural diagram of an anode active material layer according to some embodiments of this application;

FIG. 4 is a schematic structural top view of an anode active material layer with a recessed portion being a hole according to some embodiments of this application;

FIG. 5 is a schematic diagram of an internal structure of an anode active material layer with a recessed portion being a hole according to some embodiments of this application;

FIG. 6 is a schematic structural top view of an anode active material layer with a recessed portion being a groove according to some embodiments of this application;

FIG. 7 is a schematic diagram of an internal structure of an anode active material layer with a recessed portion being a groove according to some embodiments of this application;

FIG. 8 is a schematic structural diagram of an edge portion of a recessed portion according to some embodiments of this application; and

FIG. 9 is a schematic structural diagram of an electronic device according to some embodiments of this application.

In the accompanying drawings, the figures are not necessarily drawn to scale.

Description of numeral references: 1. anode current collector; 2. anode active material layer; 21. first surface; 22. second surface; 23. recessed portion; 3. stripe portion; 5. anode electrode plate; 6. cathode electrode plate; 7. cathode current collector; 8. cathode active material layer; 9. separator; 10. electrode assembly; 101. anode tab; 102. cathode tab; 2000. secondary battery; and 3000. electronic device.

### DETAILED DESCRIPTION

The following further describes some embodiments of this application in detail with reference to the accompanying drawings and embodiments. The detailed description of the following embodiments and the accompanying drawings are intended to illustrate the principle of this application, rather than to limit the scope of this application, meaning this application is not limited to these embodiments described herein.

In the description of this application, it should be noted that, unless otherwise stated, “a plurality of” means at least two; and the orientations or positional relationships indicated by the terms “upper”, “lower”, “left”, “right”, “inside”, “outside”, and the like are merely for ease and brevity of description of this application rather than indicating or implying that the means or components mentioned must have specific orientations or must be constructed or manipulated according to particular orientations. These terms shall therefore not be construed as limitations on this application. In addition, the terms “first”, “second”, “third”, and the like are merely for the purpose of description and shall not be understood as any indication or implication of relative importance. “Perpendicular” is not strictly perpendicular, but within the allowable range of error. “Parallel” is not strictly parallel, but within the allowable range of error.

Reference to “embodiment” in this application means that specific features, structures, or characteristics described with reference to some embodiments may be included in at least one embodiment of this application. The word “embodiment” appearing in various places in this specification does not necessarily refer to the same embodiment or an independent or alternative embodiment that is exclusive of other embodiments. It is explicitly or implicitly understood by persons skilled in the art that these embodiments described in this application may be combined with other embodiments.

The orientation terms appearing in the following description all refer to directions shown in the figures, and do not limit the specific structure of this application. In the description of this application, it should also be noted that unless otherwise specified and defined explicitly, the terms “mounting”, “connection”, and “join” should be understood in their general senses. For example, they may refer to a fixed connection, a detachable connection, or an integral connection, and may refer to a direct connection or an indirect connection via an intermediate medium. Persons of ordinary skill in the art can understand specific meanings of these terms in this application as appropriate to specific situations.

Currently, from the perspective of market development, application of batteries is being more extensive. Batteries have been not only used in energy storage power supply systems such as hydroelectric power plants, thermal power plants, wind power plants, and solar power plants, but also widely used in many other fields including electric transportation tools such as electric bicycles, electric motorcycles, and electric vehicles, communication equipment, military equipment, and aerospace. With continuous expansion of application fields of batteries, market demands for batteries are also increasing.

The following further describes, with reference to specific embodiments, technical solutions for a secondary battery, an electronic device, and a method for preparing a secondary battery provided in this application.

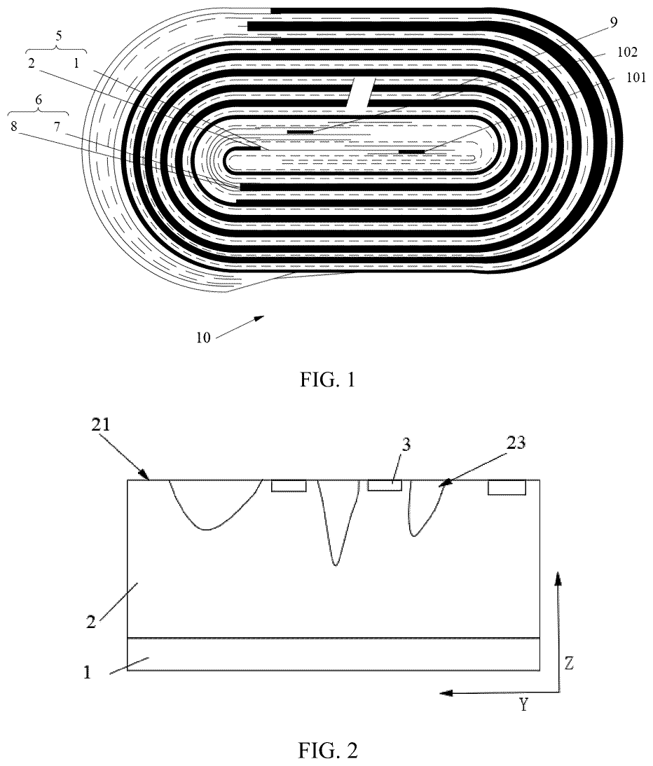

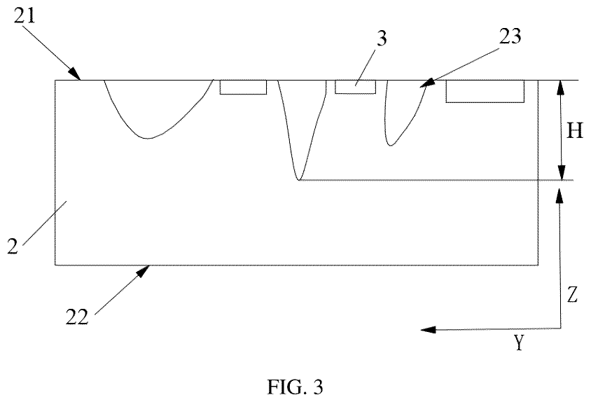

Some embodiments of this application provide a secondary battery. As shown in FIG. 1, the secondary battery includes an electrode assembly 10. The electrode assembly 10 includes a cathode electrode plate 6 and an anode electrode plate 5, and a separator 9 disposed between the cathode electrode plate 6 and the anode electrode plate 5. As shown in FIG. 2, the anode electrode plate 5 includes an anode current collector 1 and an anode active material layer 2 provided on the anode current collector 1. The anode active material layer 2 includes an anode active material; and the anode active material layer 2 has a first surface 21 facing away from the anode current collector 1, the anode active material layer 2 is provided with a recessed portion 23 recessed from the first surface 21 towards the anode current collector 1, and the first surface 21 has been subjected to a lithium supplementing process treatment.

The secondary battery can independently serve as a power source to output electrical energy externally for use. Alternatively, multiple secondary batteries can be connected in series, parallel, or series-parallel to form a battery pack, and the battery pack serves as a power source to output electrical energy externally. Being connected in series-parallel means a combination of series and parallel connections of multiple secondary batteries. The secondary battery may be a lithium-ion battery. The lithium-ion battery may refer to a secondary battery that primarily relies on movement of lithium ions between the cathode electrode plate 6 and the anode electrode plate 5 during operation. The secondary battery may be cylindrical, flat, rectangular, or of other shapes. The following provides a further description using an example of the secondary battery being a lithium-ion battery.

In the first cycle of a lithium-ion battery, a SEI film (solid electrolyte interface film) forms on a surface of a graphite negative electrode, resulting in a 5%-15% first irreversible capacity loss, and a 15%-35% loss of a high-capacity silicon-based material, and such capacity loss can be prevented by pre-lithiation technology. The pre-lithiation technology is used to supplement lithium to an electrode material, such that the active lithium released during charge compensates for the first irreversible lithium loss, forming a SEI film on the surface of the negative electrode, thereby improving the reversible cycling capacity and cycle life of the lithium battery.

In the electrode assembly 10 serving as an important component of the secondary battery, the anode electrode plate 5 includes the anode current collector 1 and the anode active material layer 2 provided on the anode current collector 1. The anode active material layer 2 may be directly formed on the surface of the anode current collector 1, or another functional layer may be provided between the anode active material layer 2 and the anode current collector 1 to achieve a preset function.

The anode active material layer 2 may be formed using a coating process to coat the anode current collector 1 with a corresponding material. The anode current collector 1 uncoated with the anode active material layer 2 protrudes out of the anode current collector 1 coated with the anode active material layer 2, and the anode current collector 1 uncoated with the anode active material layer 2 serves as an anode tab 101. In some embodiments, the anode tab 101 may also be formed by connecting a component serving as the anode tab 101 to the anode current collector through welding or other methods. In some embodiments of this application, the material of the anode current collector 1 may be metallic copper, and the copper is processed into a copper foil to form the anode current collector 1.

The anode active material includes one or more selected from the group consisting of a carbon material, a silicon materialand a tin material. Specifically, the anode active material may include at least one of graphite, amorphous carbon, Si, Sn, SiO, SnO, Si/C, Sn/C, Si halide, Sn halide, Si alloy, or Sn alloy. Persons skilled in the art can select the anode active material based on actual circumstances, as long as it does not affect the electrochemical performance of the anode electrode plate 5. Preferably, the anode active material may be graphite or amorphous carbon. Both have stable chemical properties, are corrosion-resistant, acid and alkali-resistant, and have good conductivity, helping to improve the electrochemical performance of the anode electrode plate 5.

The lithium supplementing process refers to a process of replenishing active lithium in response to the issue that part of the active lithium is consumed during the first charge and discharge cycle of the anode electrode plate 5. Active lithium is formed during the formation of the anode electrode plate 5 to compensate for the irreversible capacity loss of the first charge-discharge cycle, helping to improve the first coulombic efficiency and capacity retention rate of the battery, thereby improving the discharge performance of the battery.

The lithium supplementing process may involve disposing a lithium strip, lithium block, or lithium powder on the first surface 21. The lithium metal can react with the anode active material during the formation of the secondary battery, intercalate into the anode active material, and diffuse into the anode active material, helping to improve the first-cycle efficiency of the anode electrode plate 5.

In some embodiments, the lithium supplementing process may involve rolling a metal lithium foil to a micron-level thickness, taking advantage of the ductility of metal lithium and controlling the tape speed of the anode electrode plate 5 and the rolling speed of the metal lithium foil to obtain a rolled lithium strip on the first surface 21, and compounding the rolled lithium strip with the first surface 21 of the anode active material layer 2 to obtain the anode electrode plate 5. The lithium supplementing process may also involve rolling lithium powder on the first surface 21 to obtain a lithium powder layer on the first surface 21, and compounding the rolled lithium powder layer with the first surface 21 of the anode active material layer 2 to obtain the anode electrode plate 5. After the obtained anode electrode plate 5 is made into a secondary battery, the lithium metal used as the lithium supplementing material decomposes and disappears after the primary battery reaction.

Forming the lithium supplementing layer on the anode active material layer 2 by rolling the metal lithium foil not only has low processing costs and high processing efficiency but also reduces the contact between metal lithium and the environment, helping to reduce side reactions of the metal lithium during the lithium supplementing process.

The lithium supplementing layer on the first surface 21 may be distributed as spaced strips or a continuous electrode plate. Persons skilled in the art can arrange it based on actual circumstances. Preferably, the lithium supplementing layer is distributed as spaced strips, and the gaps between the spaced strips of the lithium supplementing layer are arranged based on actual circumstances, such that the amount of metal lithium supplemented by the lithium supplementing layer can meet the needs of the lithium supplementing process without causing excessive waste of metal lithium.

The first surface 21 is the surface of the inherent structure of the anode active material layer 2, and the surface faces away from the anode current collector 1. The recessed portion 23 in the anode active material layer 2 is recessed from the first surface 21 towards the anode current collector 1. The recessed portion 23 can serve as a lithium-ion transport channel, which not only increases the diffusion speed of lithium ions, helping to shorten the standing lithium supplement time and reduce side reactions during standing lithium supplementation, but also alleviates the problem of uneven lithium ion concentration in the thickness direction of the anode active material layer 2, accelerating the internal reaction of the anode active material layer 2 and allowing for a more sufficient reaction of the lithium supplementing material. In addition, the recessed portion 23 in the anode active material layer 2 serves as a lithium-ion transport channel, helping to improve the discharge rate performance of the secondary battery, thereby improving the discharge performance of the secondary battery.

In some embodiments of this application, as shown in FIG. 3, the anode active material layer 2 is provided with a second surface 22, where the second surface 22 is the surface of the inherent structure of the anode active material layer 2 and is parallel to and spaced apart from the first surface 21. The second surface 22 is closer to the anode current collector 1 than the first surface 21. The anode current collector 1 is disposed on the second surface 22 of the anode active material layer 2. The anode active material layer 2 including an anode active material is formed between the first surface 21 and the second surface 22. The recessed portion 23 in the first surface 21 allows the active lithium generated by the lithium supplementing material disposed on the first surface 21 to quickly diffuse into the anode active material layer 2.

The recessed portion 23 refers to a recessed structure, which is provided in the anode active material layer 2 and formed by recessing the anode active material layer 2 at the first surface 21 towards the inside. It needs to be distinguished from a possible uneven place on the first surface 21 in the prior art. The recess here may be formed through material removal using a method such as laser drilling or mechanical processing, or by pressing the first surface 21 through a method such as mechanical processing, causing a local region of the first surface 21 to be recessed towards the inside of the anode active material layer 2. The recessed portion 23 is formed in the first surface 21 of the anode active material layer 2 through material removal. Processing the anode active material layer 2 on the outer side of the first surface 21 through material removal makes the recessed portion 23 a recess in the anode active material layer 2.

In some embodiments of this application, the anode active material layer 2 further includes an anode binder. The anode binder refers to a material that is mixed into the material forming the anode active material layer 2 and provides an adhesion function, which not only enables the anode active material layer 2 to adhere to the anode current collector 1, but also allows the anode active material in the anode active material layer 2 to adhere together as a whole.

The anode binder includes at least one of styrene-butadiene rubber, polyvinylidene fluoride, polytetrafluoroethylene, fluorinated rubber, polyurethane, polyacrylic acid, sodium polyacrylate, polyvinyl alcohol, alginate, or sodium alginate. Preferably, the anode binder includes styrene-butadiene rubber. Styrene-butadiene rubber features wear resistance, heat resistance, and aging resistance, helping to prolong the service life of the anode electrode plate 5.

In some embodiments of this application, the anode active material layer 2 further includes a thickener. The thickener refers to a material that is mixed into the material forming the anode active material layer 2 and is used to increase the viscosity of a system, allowing the system to maintain a uniform and stable suspension or emulsion state, which helps uniform distribution of various materials in the anode active material layer 2.

In some embodiments of this application, the anode active material layer 2 further includes an anode conductive agent. The anode conductive agent includes at least one of acetylene black, conductive carbon black, carbon fiber, carbon nanotubes, or Ketjen black. Preferably, the anode conductive agent includes conductive carbon black. Conductive carbon black includes at least one of Super P, Super S, or 350G, which has good conductivity, moderate specific surface area, excellent processing performance, and no impact on the electrochemical mechanism.

In some embodiments of this application, the anode binder includes silicone resin, and a mass percentage of the silicone resin in the anode active material layer 2 is 1%. The thickener includes sodium carboxymethyl cellulose, and a mass percentage of the sodium carboxymethyl cellulose in the anode active material layer 2 is 1%.

In some embodiments of this application, the recessed portion 23 is formed through a laser processing process. Because laser has energy, a laser beam interacts with materials and can remove materials such as the anode active material and binder, to form the recessed portion 23 in the first surface 21 of the anode active material layer 2. The laser processing process can remove the material of the anode active material layer 2 to form the recessed portion 23, providing a good effect of the recessed portion 23 on ion diffusion. In addition, the adhesion strength and compacted density of the surrounding material of the recessed portion 23 are not affected when the binder at the processed portion is removed.

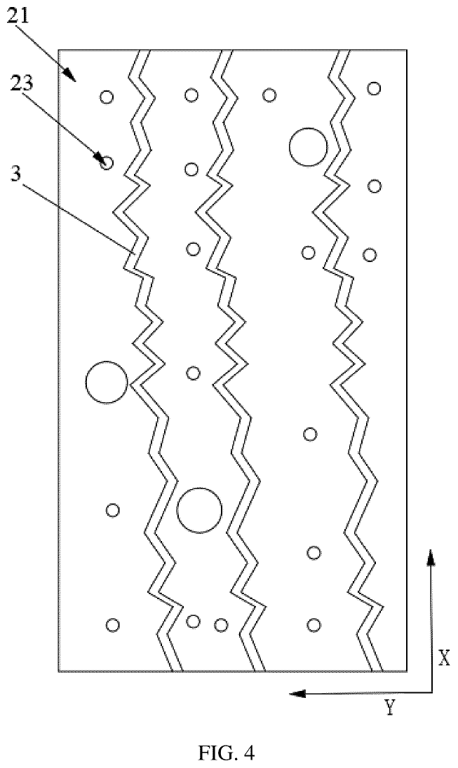

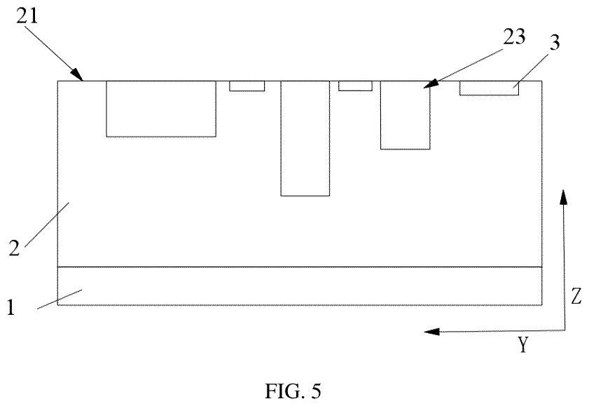

In some embodiments of this application, the recessed portion 23 includes a hole and/or a groove. As shown in FIGS. 4 and 5, the hole is a hole-shaped structure provided in the anode active material layer 2 and its cross-sectional shape may be circular, triangular, square, or polygonal. The cross-sectional shape of the hole may further be another irregular closed curve. Persons skilled in the art can arrange the cross-sectional shape of the hole based on actual circumstances. Because a hole facilitates positioning during the processing, the recessed portion 23 including a hole allows for accurate positioning of the recessed portion 23 during the processing, helping to achieve precise control of the recessed portion 23. It can be understood that the diameters of multiple holes may be set to be the same or different. The positions of the multiple holes may be arranged as a matrix, a circumferential array, or according to other preset rules, or in a random order. The arrangement method of the multiple holes can be arranged by persons skilled in the art based on actual circumstances.

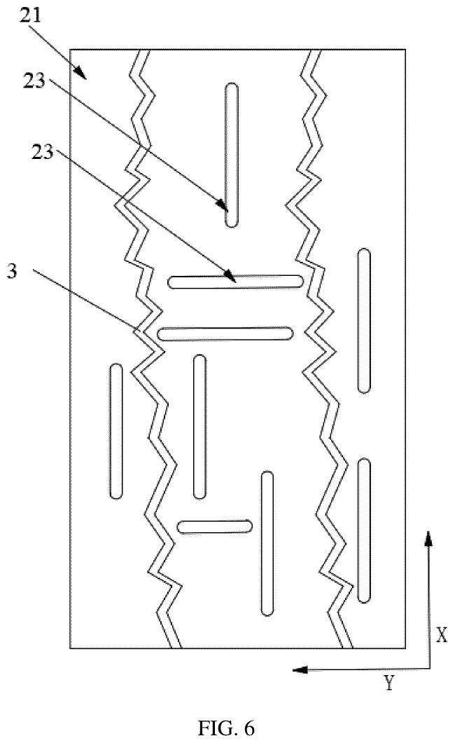

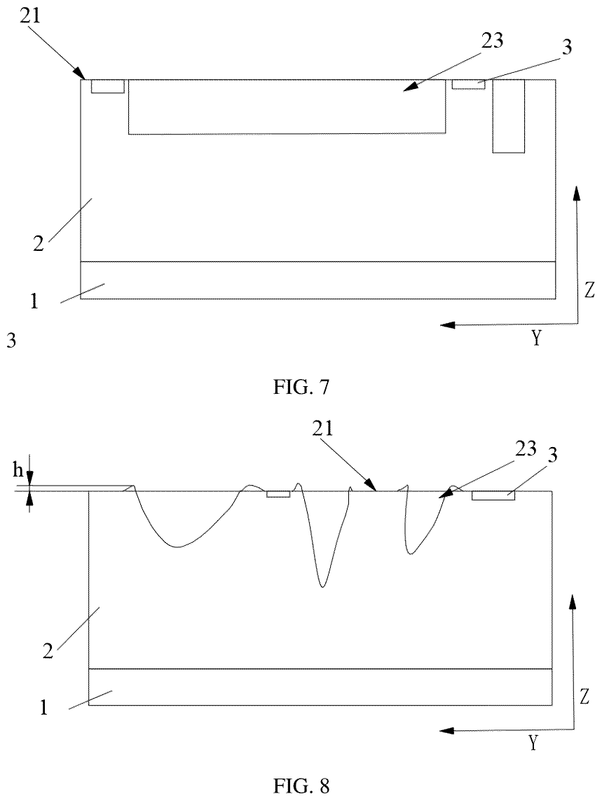

As shown in FIGS. 6 and 7, the groove is a groove-shaped structure provided in the anode active material layer 2, having a length along the arrangement direction of the anode active material layer 2. The cross section of the groove may be V-shaped or U-shaped. Persons skilled in the art can arrange the shape of the cross section of the groove based on actual circumstances. Because the groove allows for continuous processing with high processing efficiency, the recessed portion 23 includes a groove, thus achieving continuous processing of the recessed portion 23, which helps to improve the processing efficiency of the recessed portion 23. It can be understood that the continuous extension direction of the groove can be arranged along the length direction of the anode active material layer 2 or along the width direction of the anode active material layer 2. The length direction of the anode active material layer 2 is direction X in FIG. 6, and the width direction of the anode active material layer 2 is direction Y in FIG. 6. It can be understood that the continuous extension direction of the groove can be arranged by persons skilled in the art based on actual circumstances.

In some embodiments of this application, the cross section of the recessed portion 23 is V-shaped. The thickness direction of the anode active material layer 2 refers to direction Z in FIG. 3. As shown in FIG. 3, the cross section of the recessed portion 23 refers to the cross section in the thickness direction of the anode active material layer 2. The cross section of the recessed portion 23 being V-shaped means that the recessed portion 23 is conical, and the area of the opening of the recessed portion 23 in the first surface 21 is greater than the area of the bottom of the recessed portion 23. This shape of the recessed portion 23 facilitates processing and reduces processing difficulty, helping to improve the processing efficiency of the recessed portion 23.

In some embodiments of this application, a radius of the recessed portion 23 is R μm, and 10≤R≤50. The radius of the recessed portion 23 refers to the radius of a circle with an area equivalent to the area of the recessed portion 23. Specifically, the area of the pattern formed by the recessed portion 23 in the first surface 21 is taken as an area of an equivalent circle, and the radius of the equivalent circle calculated based on the area of the equivalent circle is the radius of the recessed portion 23. When the recessed portion 23 is a hole, the area of the pattern formed by the hole in the first surface 21 is first measured, and the radius of the equivalent circle calculated based on the measured area is the radius of the recessed portion 23. When the recessed portion 23 is a groove, the area of the pattern formed by the groove in the first surface 21 is first measured, and the radius of the equivalent circle calculated based on the measured area is the radius of the recessed portion 23.

The area of the pattern formed by the recessed portion 23 in the first surface 21 can be obtained by capturing an image of the first surface 21 of the anode electrode plate 5 with a charge-coupled device (CCD, Charge coupled Device) camera, and measuring the area of the recessed portion 23 in the image.

The radius of the recessed portion 23 is greater than or equal to 10 μm and less than or equal to 50 μm. The recessed portion 23 within this size range serves as a lithium-ion transport channel. This can improve the lithium-ion transport efficiency, shorten the standing lithium supplement time, and reduce the impact of the recessed portion 23 on the first surface 21, thereby maintaining the original morphology of the first surface 21 and reducing the adverse impact on the electrochemical performance of the anode active material layer 2.

In some embodiments of this application, 30≤R≤50. The radius of the recessed portion 23 is greater than or equal to 30 μm and less than or equal to 50 μm. The recessed portion 23 within this size range serves as a lithium-ion transport channel, which can further improve the lithium-ion transport efficiency on the basis of reducing the impact of the recessed portion 23 on the first surface 21 and maintaining the original morphology of the first surface 21, allowing for a more significant effect of shortening the standing lithium supplement time.

In some embodiments of this application, the depth of the recessed portion 23 is H μm, and 8≤H≤30. As shown in FIG. 3, the depth of the recessed portion 23 is greater than or equal to 5 μm and less than or equal to 30 μm, such that the recessed portion 23 can effectively diffuse ions and also reduce the impact on the adhesion of the anode active material layer 2, reducing the possibility of the anode active material layer 2 falling off the anode current collector 1.

In some embodiments of this application, 15≤H≤30. The depth of the recessed portion 23 is greater than or equal to 15 μm and less than or equal to 30 μm, such that the recessed portion 23 minimizes the impact on the adhesion of the anode active material layer 2 and effectively diffuses ions.

In some embodiments of this application, the anode active material layer 2 is provided with a plurality of the recessed portions 23, the distance between two adjacent recessed portions 23 is L μm, and 50≤L≤300.

The plurality of the recessed portions 23 refer to three or more recessed portions 23 provided in the anode active material layer 2. The plurality of the recessed portions 23 make the anode active material layer 2 a porous structure, helping to increase the porosity of the anode electrode plate 5 and improve the discharge rate performance of the secondary battery.

The distance between two adjacent recessed portions 23 may refer to the shortest distance between the edges of two adjacent recessed portions 23. Setting the distance between two adjacent recessed portions 23 allows the plurality of the recessed portions 23 to be distributed uniformly in the first surface 21 of the anode active material layer 2, such that lithium ions generated through the reaction of the lithium supplementing material in the anode active material layer 2 can diffuse uniformly into the anode active material layer 2 via the recessed portions 23, thereby reducing the possibility of an uneven distribution of lithium ion concentration at a localized position.

The distance between two adjacent recessed portions 23 is greater than or equal to 50 μm and less than or equal to 300 μm. This distance range allows the plurality of the recessed portions 23 to have a sufficient lithium ion diffusion capacity, enabling the lithium ions generated by the lithium supplementing process on the first surface 21 of the anode active material layer 2 to diffuse quickly and thoroughly into the anode active material layer 2. Additionally, this distance range ensures that the distance between recessed portions 23 is not excessively small, helping to reduce the processing difficulty of the anode electrode plate 5. Optionally, the distance between two adjacent recessed portions 23 is set to 150 μm or 250 μm, allowing the recessed portions 23 to have a sufficient lithium ion diffusion capacity and the recessed portions 23 in the anode active material layer 2 to be processed easily, helping to reduce the processing difficulty of the anode electrode plate 5.

In some embodiments of this application, 50≤L≤150. The distance between two adjacent recessed portions 23 is greater than or equal to 50 μm and less than or equal to 150 μm. This distance range allows the plurality of the recessed portions 23 to have a sufficient lithium ion diffusion capacity on a basis of reducing the processing difficulty.

In some embodiments of this application, the anode active material layer 2 is provided with a plurality of the recessed portions 23, the radius of the recessed portion 23 is R μm, the depth of the recessed portion 23 is H μm, and the distance between two adjacent recessed portions 23 is L μm, A=L/(R×H) is defined, and 0.20≤A≤5.00. A is defined as a parameter of the recessed portion 23, and A=L/(R×H). Using A as a parameter of the recessed portion 23 is conducive to setting a relationship between the radius, depth, and distance of the recessed portion 23. The parameter A of the recessed portion 23 being greater than or equal to 0.20 and less than or equal to 5.00 helps to improve the lithium-ion diffusion capability of the recessed portion 23. Preferably, the parameter A of the recessed portion 23 is 2.00, where L=200, R=5, and H=20. This parameter for the recessed portion 23 not only facilitates processing but also allows the recessed portion 23 to have a sufficient lithium ion diffusion capacity.

In some embodiments of this application, 0.20≤A≤3.50. The parameter A of the recessed portion 23 being greater than or equal to 0.20 and less than or equal to 3.50 helps to further improve the lithium-ion diffusion capability of the recessed portion 23.

In some embodiments of this application, a height of an edge portion of the recessed portion 23 protruding out of the first surface 21 is h μm, and 3≤h≤10.

The edge portion of the recessed portion 23 refers to the opening of the recessed portion 23 in the first surface 21 of the anode active material layer 2. As shown in FIG. 8, processing the recessed portion 23 in the anode active material layer 2 causes some impact on the first surface 21, causing the material at the opening of the recessed portion 23 to accumulate and protrude out of the first surface 21. The edge portion of the recessed portion 23 protruding out of the first surface 21 not only increases the diffusion area of the diffusion channel, helping to improve the lithium ion diffusion effect of the recessed portion 23, but also increases the contact area between the anode active material layer 2 and the electrolyte for reaction, helping to increase the sites of reaction between the anode active material layer 2 and the electrolyte and improve the discharge rate performance of the secondary battery. The edge portion of the recessed portion 23 can be formed during the laser processing process for the recessed portion 23. Due to the energy of the laser, when the anode active material layer 2 is melted, the material at the opening of the recessed portion 23 accumulates and the edge portion of the recessed portion 23 protrudes out of the first surface 21. Persons skilled in the art can regulate the laser power and irradiation time to adjust the height of the edge portion of the recessed portion 23 protruding out of the first surface 21.

The height of the edge portion of the recessed portion 23 protruding out of the first surface 21 is greater than or equal to 3 μm and less than or equal to 10 μm, allowing the edge portion to increase the contact area and reduce the impact of the recessed portion 23 on the roughness of the first surface 21 of the anode active material layer 2, thereby reducing the impact on the interface between the cathode electrode plate 6 and the anode electrode plate 5.

In some embodiments of this application, as shown in FIGS. 1 to 3, the anode electrode plate 5 has a stripe portion 3 exposed from the first surface 21 and extending in a first direction. In the direction perpendicular to the first direction, the width range of the stripe portion 3 is 0.1 mm to 2.0 mm; and/or the thickness range of the stripe portion 3 is 0.04 μm to 0.50 μm.

The first direction may refer to a conveying direction of the anode electrode plate 5 when the metal lithium foil is rolled onto the first surface 21 during the lithium supplementing process.

The stripe portion 3 may refer to a structure formed on the first surface 21 of the anode active material layer 2 during the lithium supplementing process. During the lithium supplementing process, due to the high reactivity of metal lithium and the presence of oxygen and moisture in the environment, the metal lithium foil rolled onto the first surface 21 to form the lithium supplementing layer reacts with the oxygen and moisture in the environment, generating a layer of by-products. After the subsequent primary battery reaction and formation of the anode electrode plate 5, the metal lithium foil, as the lithium supplementing material, disappears after reaction, leaving the by-products on the first surface 21 to form the stripe portion 3.

The width direction of the stripe portion 3 refers to a direction of the first surface 21 perpendicular to the first direction. The width of the stripe portion 3 is consistent with the width of the lithium supplementing layer formed during the lithium supplementing process. The width range of the stripe portion 3 is 0.1 mm to 2.0 mm (that is, the width range of the lithium supplementing layer formed during the lithium supplementing process is 0.1 mm to 2.0 mm). This width range facilitates processing of the metal lithium foil during the lithium supplementing process, helping to reduce the processing difficulty. Preferably, the width of the stripe portion 3 is set to 1.0 mm or 1.5 mm, helping to increase the processing difficulty of the lithium supplementing layer during the lithium supplementing process, thus improving the processing efficiency.

The thickness direction of the stripe portion 3 refers to a thickness direction of the anode active material layer 2, and the thickness of the stripe portion 3 refers to the thickness of the by-products generated during the lithium supplementing process. The thickness range of the stripe portion 3 is 0.04 μm to 0.50 μm. This thickness range is controlled based on the side reactions of metal lithium during the lithium supplementing process. Those skilled in the art can control the oxygen and moisture content in the environment to control the side reactions of metal lithium during the lithium supplementing process, so as to control the thickness of the stripe portion 3. Preferably, the thickness of the stripe portion 3 is set to 0.11 μm or 0.30 μm, helping to keep the resistance of the first surface 21 of the anode electrode plate 5 within a reasonable range.

The width of the stripe portion 3 can be obtained through photographing and measuring. A CCD camera is used to photograph the first surface 21 of the anode active material layer 2, to obtain an image of the first surface 21 of the anode active material layer 2. Then, the width of the stripe portion 3 in the image is measured to obtain the width of the stripe portion 3.

The thickness of the stripe portion 3 can be obtained through photographing of a slice sample of the anode electrode plate 5 and measuring. The anode electrode plate 5 is cut in the thickness direction of the anode electrode plate 5 to obtain a slice sample, a section of the anode electrode plate 5 is photographed to obtain an image of the section of the anode electrode plate 5, and then the thickness of the stripe portion 3 in the image is measured to obtain the thickness of the stripe portion 3.

In some embodiments of this application, the anode active material layer 2 further includes a lithium compound exposed from the first surface 21, and the lithium compound includes one or more of lithium carbonate and lithium oxide.

The lithium compound refers to a composition of the stripe portion 3 formed on the first surface 21 of the anode active material layer 2 after the lithium supplementing process. The lithium compound is generated through the side reactions of metal lithium during the lithium supplementing process. The lithium compound on the first surface 21 helps to increase the surface resistance of the anode electrode plate 5, reduce the short-circuit current of the secondary battery, and lower the risk of thermal runaway caused by short circuit of the anode electrode plate 5. The lithium compound such as lithium carbonate or lithium oxide is a substance, which is generated through the side reaction of lithium foil or lithium powder during the lithium supplementing process, and remains on the first surface 21 of the anode active material layer 2. If the amount of the lithium compound is within a certain range, it can serve as an insulating layer. However, if the amount of the lithium compound exceeds a certain range, the intercalation of lithium ions is affected, causing a risk of lithium precipitation.

In some embodiments of this application, the stripe portion 3 includes the above lithium compound, meaning that the stripe portion 3 includes one or more of lithium carbonate and lithium oxide.

In some embodiments of this application, the anode electrode plate 5 further includes a conductive layer disposed on the first surface 21, and the conductive layer includes a conductive agent and a binder.

The conductive layer can be formed by coating the anode active material layer 2 with an appropriate material using a coating process. The lithium supplementing material is then disposed on the conductive layer, helping to improve the conduction capability of the anode active material layer and enhance the efficiency of the lithium supplementing process.

The conductive agent includes at least one of acetylene black, conductive carbon black, carbon fiber, carbon nanotubes, or Ketjen black. Preferably, the anode conductive agent includes conductive carbon black. Conductive carbon black includes at least one of Super P, Super S, or 350G, which has good conductivity, moderate specific surface area, excellent processing performance, and no impact on the electrochemical mechanism.

The binder refers to a material that is mixed into the material forming the conductive layer and provides an adhesion function, which not only enables the conductive layer to adhere to the anode active material layer 2, but also allows the material in the conductive layer, such as the conductive agent, to adhere together as a whole.

The binder includes at least one of styrene-butadiene rubber, polyvinylidene fluoride, polytetrafluoroethylene, fluorinated rubber, polyurethane, polyacrylic acid, sodium polyacrylate, polyvinyl alcohol, alginate, or sodium alginate. Preferably, the binder includes styrene-butadiene rubber. Styrene-butadiene rubber features wear resistance, heat resistance, and aging resistance, helping to prolong the service life of the anode electrode plate 5.

In some embodiments of this application, the thickness of the conductive layer is B μm, where 0.5≤B≤8.0. The thickness direction of the conductive layer refers to the thickness direction of the anode active material layer 2 in the anode electrode plate 5. The conductive layer with a thickness range of 0.5 μm to 8.0 μm not only provides good conduction capability but also minimizes the impact on the thickness of the anode electrode plate 5.

Preferably, the thickness of the conductive layer is set to 3.5 μm or 6.5 μm, allowing for good conduction capability of the conductive layer and minimizing the impact on the thickness of the anode electrode plate 5.

In some embodiments of this application, the porosity of the conductive layer is C, and 30%≤C≤60%. The conductive layer may be provided with pores, making the conductive layer a porous structure, which helps to improve the conduction capability of the conductive layer. The porosity of the conductive layer can be determined by measuring the porosity of a sample of the conductive layer peeled off the anode electrode plate 5. The method for measuring the porosity of the conductive layer is as follows:
peeling the conductive layer off the anode active material layer 2 and taking a test sample therefrom;
select an appropriate dilatometer based on a predicted density and porosity of the test sample;
placing the test sample in an oven and baking it for 2 h to remove moisture from the test sample;
weighing the test sample without moisture;
loading the test sample into the dilatometer, and measuring the weight after sealing, where the measured weight is the weight of the test sample and dilatometer;
placing the dilatometer in a low-pressure station and conducting low-pressure analysis according to a preset low-pressure analysis program, such that the pressure is within a range of 0.5 psi to 50 psi;
after the low-pressure analysis, removing the dilatometer for measuring the weight, where the measured weight is the weight of the test sample, the dilatometer, and mercury;
placing the dilatometer in a high-pressure station, fixing the dilatometer, and screwing in a high-pressure chamber head, ensuring the high-pressure chamber head is screwed to the bottom to expel bubbles from the dilatometer;
conducting high-pressure analysis according to a preset high-pressure analysis program, to ensure that the pressure is within a range of 100 psi to 60,000 psi; and
after the high-pressure analysis, cleaning the dilatometer, and finishing the test.

Through the above test process, the porosity volume of the test sample can be obtained by dividing the measured weight of the mercury by the density of the mercury. The porosity of the test sample can then be calculated. This process is a common technique and method used by those skilled in the art and is not described in detail herein.

In some embodiments of this application, the electrode assembly 10 further includes a cathode electrode plate 6 and a separator 9, and the cathode electrode plate 6, the separator 9, and the anode electrode plate 5 are stacked, with the first surface 21 in contact with the separator 9. This helps the electrolyte to be directly transferred into the anode electrode plate 5 via the recessed portions 23 and also helps the lithium ions de-intercalating from the cathode electrode plate 6 to pass through the separator 9 and directly enter the anode electrode plate 5 via the recessed portions 23, improving the cycling performance and rate performance.

The cathode electrode plate 6 includes a cathode current collector 7 and a cathode active material layer 8, and the cathode active material layer 8 is applied to the surface of the cathode current collector 7. The cathode active material layer 8 can be formed using a coating process to coat the cathode current collector 7 with a corresponding material. The cathode current collector 7 uncoated with the cathode active material layer 8 protrudes out of the cathode current collector 7 coated with the cathode active material layer 8, and the cathode current collector 7 uncoated with the cathode active material layer 8 serves as a cathode tab 102. In some embodiments of this application, the material of the cathode current collector 7 may be metallic aluminum, and the aluminum is processed into an aluminum foil to form the cathode current collector 7.

The cathode active material layer 8 includes a cathode active material, a cathode binder, and a cathode conductive agent. In some embodiments, the cathode active material includes lithium cobalt oxide, and a mass percentage of the lithium cobalt oxide in the cathode active material layer 8 is 95.2%. The cathode binder includes polyvinylidene fluoride, and a mass percentage of the polyvinylidene fluoride in the cathode active material layer 8 is 1.7%. The conductive agent includes conductive carbon black, and a mass percentage of the conductive carbon black in the cathode active material layer 8 is 1.6%. Preferably, the conductive carbon black may be Super P conductive carbon black, which has good conductivity, moderate specific surface area, excellent processing performance, and no impact on the electrochemical mechanism.

In some embodiments of this application, the separator 9 is a high-adhesion composite film that can isolate the anode electrode plate 5 from the cathode electrode plate 6 while having good adhesion, allowing for a firm connection between the first surface 21 of the anode active material layer 2 and the separator 9.

The following further describes beneficial effects of the secondary battery provided according to the specific embodiments of this application through comparative experiments.

A secondary battery including an anode electrode plate 5 formed by an anode active material layer 2 without the recessed portion 23 in the related art was used as an experimental object in a comparative example in the comparative experiments; and a secondary battery including an anode electrode plate 5 formed by an anode active material layer 2 with a recessed portion 23 was used as an experimental object in an example of the comparative experiment in the comparative experiments.

A method for preparing a cathode electrode plate 6 in the secondary battery might be as follows: cathode active material lithium cobalt oxide, conductive agent conductive carbon black, and binder polyvinylidene fluoride were mixed at a certain mass ratio, N-methylpyrrolidone (NMP) was added, and the mixture was stirred well under action of a vacuum mixer, to obtain a cathode slurry, where a solid content of the cathode slurry was 70 wt %. The cathode slurry was evenly applied to one surface of a cathode current collector 7 aluminum foil with a thickness of 12 μm, and the aluminum foil was dried at 120° C. for 1 h to obtain a cathode electrode plate 6 with a single surface coated with a cathode active material layer 8. The above steps were repeated on the other surface of the aluminum foil to obtain a cathode electrode plate 6 with two surfaces coated with the cathode active material layer 8. After cold pressing, cutting, and slitting, drying was performed at 120° C. for 1 h under a vacuum condition to obtain a cathode electrode plate 6 with dimensions of 74 mm×867 mm. A cathode tab 102 was welded to the cathode electrode plate 6, the cathode tab 102 being made of an aluminum foil.

The method for preparing an anode electrode plate 5 in the secondary battery might be as follows: Anode active material, binder styrene-butadiene rubber, and thickener sodium carboxymethyl cellulose were mixed at a mass ratio of 97.4:1.4:1.2, deionized water was added, and the mixture was stirred well under action of a vacuum mixer to obtain an anode slurry, where a solid content of the anode slurry was 75 wt %. The anode slurry was evenly applied to one surface of an anode current collector 1 copper foil with a thickness of 12 μm. The copper foil was dried at 120° C. to obtain an anode with a single surface coated with an anode active material layer 2 with a coating thickness of 130 μm. The above steps were repeated on the other surface of the copper foil to obtain a anode electrode plate with two surfaces coated with the anode active material layer 2. After cold pressing, cutting, and slitting, drying was performed at 120° C. for 1 h under a vacuum condition to obtain an anode electrode plate 5 with dimensions of 78 mm×875 mm. An anode tab 101 was welded to the anode electrode plate 5, the anode tab 101 being made of a nickel-plated copper foil.

A porous polyethylene film with a thickness of 7 μm was selected as a separator 9 in the secondary battery.

The prepared cathode electrode plate 6, separator 9, and anode electrode plate 5 were stacked sequentially, with the separator 9 sandwiched between the cathode electrode plate 6 and the anode electrode plate 5 to provide an isolating function, and then wound to obtain an electrode assembly 10. The electrode assembly 10 was assembled with a shell to obtain a packaged secondary battery, water was removed at 80° C., and a prepared electrolyte was injected, followed by processes such as packaging, standing, and formation, to obtain a secondary battery. The electrolyte might be prepared from ethylene carbonate, propylene carbonate, and diethyl carbonate at a mass ratio of 1:1:1, with a lithium hexafluorophosphate concentration of 1.15 mol/L.

The differences between the anode electrode plates 5 in the comparative examples and the examples are as follows:

### Comparative Example 1

The anode active material was Si, and a metal lithium foil was used as a lithium supplementing material. Before the anode electrode plate 5 was cold pressed, the metal lithium foil was rolled onto a surface of the anode active material layer 2. A standing lithium supplement time was 24 h, the anode active material layer 2 was provided with no recessed portion 23, and a secondary battery made from this anode electrode plate 5 was used as an experimental object.

### Example 1

The anode active material was Si, and a metal lithium foil was used as a lithium supplementing material. Before the anode electrode plate 5 was cold pressed, the metal lithium foil was rolled onto the surface of the anode active material layer 2. A standing lithium supplement time was 24 h. The anode active material layer 2 was provided with a recessed portion 23 through laser drilling, with a parameter A of the recessed portion 23 satisfying L/(R×H)=2.00, where L=200, R=5, and H=20.

### Example 2

The anode active material was Si, and a metal lithium foil was used as a lithium supplementing material. Before the anode electrode plate 5 was cold pressed, the metal lithium foil was rolled onto the surface of the anode active material layer 2. A standing lithium supplement time was 7 h. The anode active material layer 2 was provided with a recessed portion 23 through laser drilling, with a parameter A of the recessed portion 23 satisfying L/(R×H)=2.00, where L=200, R=5, and H=20.

### Example 3

The anode active material was Si, and a metal lithium foil was used as a lithium supplementing material. Before the anode electrode plate 5 was cold pressed, the metal lithium foil was rolled onto the surface of the anode active material layer 2. A standing lithium supplement time was 7 h. The anode active material layer 2 was provided with a recessed portion 23 through laser drilling, with a parameter A of the recessed portion 23 satisfying L/(R×H)=1.00, where L=200, R=10, and H=20.

### Example 4

The anode active material was Si, and a metal lithium foil was used as a lithium supplementing material. Before the anode electrode plate 5 was cold pressed, the metal lithium foil was rolled onto the surface of the anode active material layer 2. A standing lithium supplement time was 7 h. The anode active material layer 2 was provided with a recessed portion 23 through laser drilling, with a parameter A of the recessed portion 23 satisfying L/(R×H)=0.50, where L=200, R=20, and H=20.

### Example 5

The anode active material was Si, and a metal lithium foil was used as a lithium supplementing material. Before the anode electrode plate 5 was cold pressed, the metal lithium foil was rolled onto the surface of the anode active material layer 2. A standing lithium supplement time was 7 h. The anode active material layer 2 was provided with a recessed portion 23 through laser drilling, with a parameter A of the recessed portion 23 satisfying L/(R×H)=0.33, where L=200, R=30, and H=20.

### Example 6

The anode active material was Si, and a metal lithium foil was used as a lithium supplementing material. Before the anode electrode plate 5 was cold pressed, the metal lithium foil was rolled onto the surface of the anode active material layer 2. A standing lithium supplement time was 7 h. The anode active material layer 2 was provided with a recessed portion 23 through laser drilling, with a parameter A of the recessed portion 23 satisfying L/(R×H)=0.25, where L=200, R=40, and H=20.

### Example 7

The anode active material was Si, and a metal lithium foil was used as a lithium supplementing material. Before the anode electrode plate 5 was cold pressed, the metal lithium foil was rolled onto the surface of the anode active material layer 2. A standing lithium supplement time was 7 h. The anode active material layer 2 was provided with a recessed portion 23 through laser drilling, with a parameter A of the recessed portion 23 satisfying L/(R×H)=0.20, where L=200, R=50, and H=20.

### Example 8

The anode active material was Si, and a metal lithium foil was used as a lithium supplementing material. Before the anode electrode plate 5 was cold pressed, the metal lithium foil was rolled onto the surface of the anode active material layer 2. A standing lithium supplement time was 7 h. The anode active material layer 2 was provided with a recessed portion 23 through laser drilling, with a parameter A of the recessed portion 23 satisfying L/(R×H)=0.18, where L=200, R=55, and H=20.

### Example 9

The anode active material was Si, and a metal lithium foil was used as a lithium supplementing material. Before the anode electrode plate 5 was cold pressed, the metal lithium foil was rolled onto the surface of the anode active material layer 2. A standing lithium supplement time was 7 h. The anode active material layer 2 was provided with a recessed portion 23 through laser drilling, with a parameter A of the recessed portion 23 satisfying L/(R×H)=13.33, where L=200, R=5, and H=3.

### Example 10

The anode active material was Si, and a metal lithium foil was used as a lithium supplementing material. Before the anode electrode plate 5 was cold pressed, the metal lithium foil was rolled onto the surface of the anode active material layer 2. A standing lithium supplement time was 7 h. The anode active material layer 2 was provided with a recessed portion 23 through laser drilling, with a parameter A of the recessed portion 23 satisfying L/(R×H)=8.00, where L=200, R=5, and H=5.

### Example 11

The anode active material was Si, and a metal lithium foil was used as a lithium supplementing material. Before the anode electrode plate 5 was cold pressed, the metal lithium foil was rolled onto the surface of the anode active material layer 2. A standing lithium supplement time was 7 h. The anode active material layer 2 was provided with a recessed portion 23 through laser drilling, with a parameter A of the recessed portion 23 satisfying L/(R×H)=5.00, where L=200, R=5, and H=8.

### Example 12

The anode active material was Si, and a metal lithium foil was used as a lithium supplementing material. Before the anode electrode plate 5 was cold pressed, the metal lithium foil was rolled onto the surface of the anode active material layer 2. A standing lithium supplement time was 7 h. The anode active material layer 2 was provided with a recessed portion 23 through laser drilling, with a parameter A of the recessed portion 23 satisfying L/(R×H)=4.00, where L=200, R=5, and H=10.

### Example 13

The anode active material was Si, and a metal lithium foil was used as a lithium supplementing material. Before the anode electrode plate 5 was cold pressed, the metal lithium foil was rolled onto the surface of the anode active material layer 2. A standing lithium supplement time was 7 h. The anode active material layer 2 was provided with a recessed portion 23 through laser drilling, with a parameter A of the recessed portion 23 satisfying L/(R×H)=2.67, where L=200, R=5, and H=15.

### Example 14

The anode active material was Si, and a metal lithium foil was used as a lithium supplementing material. Before the anode electrode plate 5 was cold pressed, the metal lithium foil was rolled onto the surface of the anode active material layer 2. A standing lithium supplement time was 7 h. The anode active material layer 2 was provided with a recessed portion 23 through laser drilling, with a parameter A of the recessed portion 23 satisfying L/(R×H)=2.00, where L=200, R=5, and H=20.

### Example 15

The anode active material was Si, and a metal lithium foil was used as a lithium supplementing material. Before the anode electrode plate 5 was cold pressed, the metal lithium foil was rolled onto the surface of the anode active material layer 2. A standing lithium supplement time was 7 h. The anode active material layer 2 was provided with a recessed portion 23 through laser drilling, with a parameter A of the recessed portion 23 satisfying L/(R×H)=1.33, where L=200, R=5, and H=30.

### Example 16

The anode active material was Si, and a metal lithium foil was used as a lithium supplementing material. Before the anode electrode plate 5 was cold pressed, the metal lithium foil was rolled onto the surface of the anode active material layer 2. A standing lithium supplement time was 7 h. The anode active material layer 2 was provided with a recessed portion 23 through laser drilling, with a parameter A of the recessed portion 23 satisfying L/(R×H)=1.14, where L=200, R=5, and H=35.

### Example 17

The anode active material was Si, and a metal lithium foil was used as a lithium supplementing material. Before the anode electrode plate 5 was cold pressed, the metal lithium foil was rolled onto the surface of the anode active material layer 2. A standing lithium supplement time was 7 h. The anode active material layer 2 was provided with a recessed portion 23 through laser drilling, with a parameter A of the recessed portion 23 satisfying L/(R×H)=0.40, where L=40, R=5, and H=20,

### Example 18

The anode active material was Si, and a metal lithium foil was used as a lithium supplementing material. Before the anode electrode plate 5 was cold pressed, the metal lithium foil was rolled onto the surface of the anode active material layer 2. A standing lithium supplement time was 7 h. The anode active material layer 2 was provided with a recessed portion 23 through laser drilling, with a parameter A of the recessed portion 23 satisfying L/(R×H)=0.50, where L=50, R=5, and H=20.

### Example 19

The anode active material was Si, and a metal lithium foil was used as a lithium supplementing material. Before the anode electrode plate 5 was cold pressed, the metal lithium foil was rolled onto the surface of the anode active material layer 2. A standing lithium supplement time was 7 h. The anode active material layer 2 was provided with a recessed portion 23 through laser drilling, with a parameter A of the recessed portion 23 satisfying L/(R×H)=1.00, where L=100, R=5, and H=20.

### Example 20

The anode active material was Si, and a metal lithium foil was used as a lithium supplementing material. Before the anode electrode plate 5 was cold pressed, the metal lithium foil was rolled onto the surface of the anode active material layer 2. A standing lithium supplement time was 7 h. The anode active material layer 2 was provided with a recessed portion 23 through laser drilling, with a parameter A of the recessed portion 23 satisfying L/(R×H)=1.50, where L=150, R=5, and H=20.

### Example 21

The anode active material was Si, and a metal lithium foil was used as a lithium supplementing material. Before the anode electrode plate 5 was cold pressed, the metal lithium foil was rolled onto the surface of the anode active material layer 2. A standing lithium supplement time was 7 h. The anode active material layer 2 was provided with a recessed portion 23 through laser drilling, with a parameter A of the recessed portion 23 satisfying L/(R×H)=2.00, where L=200, R=5, and H=20.

### Example 22

The anode active material was Si, and a metal lithium foil was used as a lithium supplementing material. Before the anode electrode plate 5 was cold pressed, the metal lithium foil was rolled onto the surface of the anode active material layer 2. A standing lithium supplement time was 7 h. The anode active material layer 2 was provided with a recessed portion 23 through laser drilling, with a parameter A of the recessed portion 23 satisfying L/(R×H)=3.00, where L=300, R=5, and H=20.

### Example 23

The anode active material was Si, and a metal lithium foil was used as a lithium supplementing material. Before the anode electrode plate 5 was cold pressed, the metal lithium foil was rolled onto the surface of the anode active material layer 2. A standing lithium supplement time was 7 h. The anode active material layer 2 was provided with a recessed portion 23 through laser drilling, with a parameter A of the recessed portion 23 satisfying L/(R×H)=3.50, where L=350, R=5, and H=20.

### Example 24

The anode active material was Sn, and a metal lithium foil was used as a lithium supplementing material. Before the anode electrode plate 5 was cold pressed, the metal lithium foil was rolled onto the surface of the anode active material layer 2. A standing lithium supplement time was 7 h. The anode active material layer 2 was provided with a recessed portion 23 through laser drilling, with a parameter A of the recessed portion 23 satisfying L/(R×H)=2.00, where L=200, R=5, and H=20.

### Example 25

The anode active material was Sn alloy, and a metal lithium foil was used as a lithium supplementing material. Before the anode electrode plate 5 was cold pressed, the metal lithium foil was rolled onto the surface of the anode active material layer 2. A standing lithium supplement time was 7 h. The anode active material layer 2 was provided with a recessed portion 23 through laser drilling, with a parameter A of the recessed portion 23 satisfying L/(R×H)=2.00, where L=200, R=5, and H=20.

### Example 26

The anode active material was SnO, and a metal lithium foil was used as a lithium supplementing material. Before the anode electrode plate 5 was cold pressed, the metal lithium foil was rolled onto the surface of the anode active material layer 2. A standing lithium supplement time was 7 h. The anode active material layer 2 was provided with a recessed portion 23 through laser drilling, with a parameter A of the recessed portion 23 satisfying L/(R×H)=2.00, where L=200, R=5, and H=20.

### Example 27

The anode active material was Si/C, and a metal lithium foil was used as a lithium supplementing material. Before the anode electrode plate 5 was cold pressed, the metal lithium foil was rolled onto the surface of the anode active material layer 2. A standing lithium supplement time was 7 h. The anode active material layer 2 was provided with a recessed portion 23 through laser drilling, with a parameter A of the recessed portion 23 satisfying L/(R×H)=2.00, where L=200, R=5, and H=20.

### Example 28

The anode active material was Sn/C, and a metal lithium foil was used as a lithium supplementing material. Before the anode electrode plate 5 was cold pressed, the metal lithium foil was rolled onto the surface of the anode active material layer 2. A standing lithium supplement time was 7 h. The anode active material layer 2 was provided with a recessed portion 23 through laser drilling, with a parameter A of the recessed portion 23 satisfying L/(R×H)=2.00, where L=200, R=5, and H=20.

### Example 29

The anode active material was Si halide, and a metal lithium foil was used as a lithium supplementing material. Before the anode electrode plate 5 was cold pressed, the metal lithium foil was rolled onto the surface of the anode active material layer 2. A standing lithium supplement time was 7 h. The anode active material layer 2 was provided with a recessed portion 23 through laser drilling, with a parameter A of the recessed portion 23 satisfying L/(R×H)=2.00, where L=200, R=5, and H=20.

### Example 30

The anode active material was Sn halide, and a metal lithium foil was used as a lithium supplementing material. Before the anode electrode plate 5 was cold pressed, the metal lithium foil was rolled onto the surface of the anode active material layer 2. A standing lithium supplement time was 7 h. The anode active material layer 2 was provided with a recessed portion 23 through laser drilling, with a parameter A of the recessed portion 23 satisfying L/(R×H)=2.00, where L=200, R=5, and H=20.

### Example 31

The anode active material was Si alloy, and a metal lithium foil was used as a lithium supplementing material. Before the anode electrode plate 5 was cold pressed, the metal lithium foil was rolled onto the surface of the anode active material layer 2. A standing lithium supplement time was 7 h. The anode active material layer 2 was provided with a recessed portion 23 through laser drilling, with a parameter A of the recessed portion 23 satisfying L/(R×H)=2.00, where L=200, R=5, and H=20.

### Example 32

The anode active material was Sn alloy, and a metal lithium foil was used as a lithium supplementing material. Before the anode electrode plate 5 was cold pressed, the metal lithium foil was rolled onto the surface of the anode active material layer 2. A standing lithium supplement time was 7 h. The anode active material layer 2 was provided with a recessed portion 23 through laser drilling, with a parameter A of the recessed portion 23 satisfying L/(R×H)=2.00, where L=200, R=5, and H=20.

In the above examples, the standing lithium supplement time referred to a standing time of the electrode assembly 10 in the secondary battery without electrolyte injection in a specific environment.

A design capacity of the secondary battery could be calculated based on the charge gram capacity after complete lithium de-intercalation from the anode material, in addition to theoretical exerted capacity of the lithium supplementing material.

The method for testing an actual capacity of the secondary battery was as follows: In an environment at 25° C., the secondary battery was constant-current charged at a charge rate of 0.2 C until a voltage of the secondary battery reached 4.45 V; the secondary battery was constant-voltage charged at a charge voltage of 4.45 V until the charge rate reached 0.025 C; and the secondary battery was constant-current discharged at a discharge rate of 0.2 C until the voltage of the secondary battery reached 3.0 V. The above process was repeated 3 times to take an average capacity of the secondary battery as the actual capacity of the secondary battery.

TABLE 1

| | | | | | | | | Discharge | Discharge |
|---|---|---|---|---|---|---|---|---|---|
| | Anode | | | | | Standing | Impedance | capacity retention | capacity retention |
| | active | R | H | L | | time | improvement | [symbol] | [symbol] |
| Solution | material | (μm) | (μm) | (μm) | A | (h) | [symbol] | [symbol] | [symbol] |
| Comparative | Si | / | / | / | / | 24 | 0 | 85% | 70% |
| example 1 | | | | | | | | | |
| Example 1 | Si | 5 | 20 | 200 | 2.00 | 24 | 18% | 94% | 83% |
| Example 2 | Si | 5 | 20 | 200 | 2.00 | 7 | 10% | 87% | 80% |
| Example 3 | Si | 10 | 20 | 200 | 1.00 | 7 | 15% | 93% | 84% |
| Example 4 | Si | 20 | 20 | 200 | 0.50 | 7 | 15% | 94% | 84% |
| Example 5 | Si | 30 | 20 | 200 | 0.33 | 7 | 15% | 94% | 85% |
| Example 6 | Si | 40 | 20 | 200 | 0.25 | 7 | 15% | 95% | 85% |
| Example 7 | Si | 50 | 20 | 200 | 0.20 | 7 | 16% | 95% | 86% |
| Example 8 | Si | 55 | 20 | 200 | 0.18 | 7 | 16% | 95% | 86% |
| Example 9 | Si | 5 | 3 | 200 | 13.33 | 7 | 6% | 87% | 73% |
| Example 10 | Si | 5 | 5 | 200 | 8.00 | 7 | 8% | 88% | 76% |
| Example 11 | Si | 5 | 8 | 200 | 5.00 | 7 | 10% | 90% | 80% |
| Example 12 | Si | 5 | 10 | 200 | 4.00 | 7 | 11% | 90% | 80% |
| Example 13 | Si | 5 | 15 | 200 | 2.67 | 7 | 12% | 91% | 82% |
| Example 14 | Si | 5 | 20 | 200 | 2.00 | 7 | 13% | 92% | 83% |
| Example 15 | Si | 5 | 30 | 200 | 1.33 | 7 | 14% | 94% | 85% |
| Example 16 | Si | 5 | 35 | 200 | 1.14 | 7 | 15% | 94% | 85% |
| Example 17 | Si | 5 | 20 | 40 | 0.40 | 7 | 17% | 95% | 85% |
| Example 18 | Si | 5 | 20 | 50 | 0.50 | 7 | 17% | 95% | 85% |
| Example 19 | Si | 5 | 20 | 100 | 1.00 | 7 | 16% | 95% | 84% |
| Example 20 | Si | 5 | 20 | 150 | 1.50 | 7 | 14% | 94% | 83% |
| Example 21 | Si | 5 | 20 | 200 | 2.00 | 7 | 13% | 93% | 82% |
| Example 22 | Si | 5 | 20 | 300 | 3.00 | 7 | 12% | 92% | 82% |
| Example 23 | Si | 5 | 20 | 350 | 3.50 | 7 | 10% | 90% | 81% |
| Example 24 | Sn | 5 | 20 | 200 | 2.00 | 7 | 14% | 93% | 81% |
| Example 25 | SiO | 5 | 20 | 200 | 2.00 | 7 | 16% | 92% | 81% |
| Example 26 | SnO | 5 | 20 | 200 | 2.00 | 7 | 17% | 91% | 82% |
| Example 27 | Si/C | 5 | 20 | 200 | 2.00 | 7 | 13% | 92% | 81% |
| Example 28 | Sn/C | 5 | 20 | 200 | 2.00 | 7 | 13% | 93% | 82% |
| Example 29 | Si halide | 5 | 20 | 200 | 2.00 | 7 | 14% | 94% | 82% |
| Example 30 | Sn halide | 5 | 20 | 200 | 2.00 | 7 | 15% | 92% | 81% |
| Example 31 | Si alloy | 5 | 20 | 200 | 2.00 | 7 | 13% | 93% | 83% |
| Example 32 | Sn alloy | 5 | 20 | 200 | 2.00 | 7 | 13% | 92% | 82% |

[symbol]

indicates data missing or illegible when filed

In some examples of this application, a qualitative test was also conducted to determine whether there was any residual lithium supplementing material in the anode electrode plates 5 of the secondary batteries in the above comparative examples and examples.

The test method was as follows: After formation, the secondary battery was constant-current discharged at a discharge rate of 0.2 C until the voltage of the secondary battery reached 3.0 V. The secondary battery was then disassembled, and all the material on the anode active material layer 2 (including the stripe portion 3) was scraped off. The scraped material was dried in an environment at 80° C. for 24 h. The material scraped off was then analyzed using X-ray diffraction or Raman spectroscopy to determine whether there was any residual material in the anode active material layer 2.

The discharge capacity retention rate test for the secondary batteries made from the cathode electrode plates 6 in the above comparative examples and examples was conducted as follows at a discharge rate of 2 C in an environment at 25° C.:

The secondary battery was constant-current charged at a charge rate of 0.2 C until a voltage of the secondary battery reached 4.45 V; the secondary battery was constant- voltage charged at a charge voltage of 4.45 V until the charge rate reached 0.025 C; and the secondary battery was constant-current discharged at a discharge rate of 0.2 C until the voltage of the secondary battery reached 3.0 V. The above process was repeated 3 times to take the average discharge capacity of the secondary battery as an actual discharge capacity of the secondary battery (discharge capacity at a discharge rate of 0.2 C).

The secondary battery was constant-current charged at a charge rate of 0.2 C until the voltage of the secondary battery reached 4.45 V; the secondary battery was constant-voltage charged at a charge voltage of 4.45 V until the charge rate reached 0.025 C; and the secondary battery was constant-current discharged at a discharge rate of 2 C until the voltage of the secondary battery reached 3.0 V. The above process was repeated 3 times to take the average discharge capacity as an actual discharge capacity of the secondary battery at a discharge rate of 2 C.

The actual discharge capacity of the secondary battery at the discharge rate of 2 C was divided by the actual discharge capacity of the secondary battery to obtain the discharge capacity retention rate of the secondary battery at the discharge rate of 2 C.

The discharge capacity retention rate test method at a discharge rate of 3 C in an environment at 25° C. was as follows:

The secondary battery was constant-current charged at a charge rate of 0.2 C until a voltage of the secondary battery reached 4.45 V; the secondary battery was constant-voltage charged at a charge voltage of 4.45 V until the charge rate reached 0.025 C; and the secondary battery was constant-current discharged at a discharge rate of 0.2 C until the voltage of the secondary battery reached 3.0 V. The above process was repeated 3 times to take the average discharge capacity of the secondary battery as an actual discharge capacity of the secondary battery (discharge capacity at a discharge rate of 0.2 C).

The secondary battery was constant-current charged at a charge rate of 0.2 C until the voltage of the secondary battery reached 4.45 V; the secondary battery was constant- voltage charged at a charge voltage of 4.45 V until the charge rate reached 0.025 C; and the secondary battery was constant-current discharged at a discharge rate of 3C until the voltage of the secondary battery reached 3.0 V. The above process was repeated 3 times to take the average discharge capacity as an actual discharge capacity of the secondary battery at a discharge rate of 2 C.

The actual discharge capacity of the secondary battery at the discharge rate of 3 C was divided by the actual discharge capacity of the secondary battery to obtain the discharge capacity retention rate of the secondary battery at the discharge rate of 3 C.

An impedance improvement ratio test for the secondary batteries made from the cathode electrode plates 6 in the above comparative examples and examples was conducted using the relaxation method as follows:

Direct current impedances of the secondary batteries made from the anode electrode plates 5 (without recessed portions 23) in the comparative examples and examples were measured. A specific method is as follows.

The secondary battery was placed in a constant temperature chamber at 25° C. and left standing for 30 min, allowing the secondary battery to reach a constant temperature. The secondary battery was then constant-current discharged at a discharge rate of 0.5 C until the voltage of the secondary battery reached a cutoff voltage. The secondary battery was further constant-current discharged at a discharge rate of 0.1 C until the voltage of the secondary battery reached a cutoff voltage, allowing the secondary battery to be fully discharged. The secondary battery was then constant-current charged at a charge rate of 2 C for 15 min. After standing for 120 min, the direct current impedance of the secondary battery was measured at 25% state of charge in an environment at 25° C., thereby obtaining the direct current impedances of the secondary batteries made from the anode electrode plates 5 in the comparative examples and examples.

The direct current impedance improvement ratios of the secondary batteries in the examples were calculated using the obtained direct current impedances of the secondary batteries in the comparative examples and examples. The specific calculation method for the improvement ratio was to divide the difference between the direct current impedance of the secondary battery in the example and the direct current impedance of the secondary battery in the comparative example by the direct current impedance value of the secondary battery in the example.

Table 1 provides various exemplary parameters, of the secondary batteries and cathode electrode plates 6 in the comparative examples and examples, tested in the comparative experiments of this application:

From Table 1, it can be seen through comparison between the comparative examples and the examples that within the same standing time, the material layer of the anode electrode plate 5 being provided with a recessed portion 23 can increase the decomposition speed of the lithium supplementing material and shorten the standing time. This is because the recessed portion 23 provided in the first surface 21 can serve as a lithium-ion transport channel, which can increase the diffusion speed of lithium ions, thereby increasing the decomposition speed of the lithium supplementing material and shortening the standing time.

It can be seen through comparison between Examples 2 to 23 that when 0.20≤A≤5.00, the impedance improvement ratio of the battery can reach 10% or more, indicating that when the parameter A of the recessed portion 23 satisfies 0.20≤A≤5.00, the recessed portion 23 can effectively improve the direct current impedance of the battery. The discharge capacity retention rate of the secondary battery at a discharge rate of 2 C can reach 90% or more, and the discharge capacity retention rate of the secondary battery at a discharge rate of 3 C can reach 80% or more, indicating that when the parameter A of the recessed portion 23 satisfies 0.20≤A≤5.00, the recessed portion 23 can effectively improve the discharge rate performance of the secondary battery. When A<0.20, the radius R of the recessed portion 23 and/or the depth H of the recessed portion 23 is large, or the distance L between two adjacent recessed portions 23 is small, and the further improvement effect of the recessed portion 23 on the direct current impedance and discharge rate performance of the battery is not significant. In addition, a large amount of anode active material is removed at the recessed portion 23, reducing the amount of the anode active material, which impacts the capacity of the secondary battery and causes a risk of lithium precipitation. When A>5.00, the radius R of the recessed portion 23 and/or the depth H of the recessed portion 23 is small, or the distance L between two adjacent recessed portions 23 is large, the effect of the recessed portion 23 as an ion diffusion channel is poor, and the improvement effect of the recessed portion 23 on the direct current impedance and discharge rate performance of the battery is poor.

It can be seen through comparison between Examples 2 to 8 that when 10≤R≤50, the impedance improvement ratio of the battery can reach 15% or more, indicating that when the radius R of the recessed portion 23 satisfies 10≤R≤50, the recessed portion 23 can effectively improve the direct current impedance of the battery. The discharge capacity retention rate of the secondary battery at a discharge rate of 2 C can reach 93% or more, and the discharge capacity retention rate of the secondary battery at a discharge rate of 3 C can reach 84% or more, indicating that when the radius R of the recessed portion 23 satisfies 10≤R≤50, the recessed portion 23 can effectively improve the discharge rate performance of the secondary battery. When R<10, the radius R of the recessed portion 23 is small, the effect of the recessed portion 23 as an ion diffusion channel is poor, and the improvement effect of the recessed portion 23 on the direct current impedance and discharge rate performance of the battery is poor. When R>50, although the radius R of the recessed portion 23 is large, the further improvement effect is not significant. In addition, a large amount of anode active material is removed at the recessed portion 23, reducing the amount of the anode active material, which impacts the capacity of the secondary battery and causes a risk of lithium precipitation.

It can be seen through comparison between Examples 9 to 16 that when 8≤H≤30, the impedance improvement ratio of the battery can reach 10% or more, indicating that when the depth H of the recessed portion 23 satisfies 8≤H≤30, the recessed portion 23 can effectively improve the direct current impedance of the battery. The discharge capacity retention rate of the secondary battery at a discharge rate of 2 C can reach 90% or more, and the discharge capacity retention rate of the secondary battery at a discharge rate of 3 C can reach 80% or more, indicating that when the depth H of the recessed portion 23 satisfies 8≤H≤30, the recessed portion 23 can effectively improve the discharge rate performance of the secondary battery. When H<8, the depth H of the recessed portion 23 is small, the effect of the recessed portion 23 as an ion diffusion channel is poor, and the improvement effect of the recessed portion 23 on the direct current impedance and discharge rate performance of the battery is poor. When H>30, although the depth H of the recessed portion 23 is large, the further improvement effect is not significant. In addition, a large amount of anode active material is removed at the recessed portion 23, reducing the amount of the anode active material, which impacts the capacity of the secondary battery and causes a risk of lithium precipitation.

It can be seen through comparison between Examples 17 to 23 that when 50≤L≤300, the impedance improvement ratio of the battery can reach 10% or more, indicating that when the distance L of the two adjacent recessed portion 23 satisfies 50≤L≤300, the recessed portion 23 can effectively improve the direct current impedance of the battery. The discharge capacity retention rate of the secondary battery at a discharge rate of 2 C can reach 90% or more, and the discharge capacity retention rate of the secondary battery at a discharge rate of 3 C can reach 81% or more, indicating that when the distance L of the two adjacent recessed portion 23 satisfies 50≤L≤300, the recessed portion 23 can effectively improve the discharge rate performance of the secondary battery. When L<50, the distance L between two adjacent recessed portions 23 is small, the recessed portions 23 are arranged densely, and the further improvement effect of the recessed portion 23 as an ion diffusion channel is not significant. However, due to a large number of the arranged recessed portions 23, the processing difficulty is high, and the excessive recessed portions 23 result in a large amount of removed anode active material, reducing the amount of the anode active material, impacting the capacity of the secondary battery, and causing a risk of lithium precipitation. When L>300, the distance L between two adjacent recessed portions 23 is large, the recessed portions 23 are arranged sparsely, and the improvement effect of the recessed portion 23 on the direct current impedance and discharge rate performance of the battery shows a significant downward trend.

An embodiment of this application provides a method for preparing a secondary battery. The method for preparing the secondary battery includes the following steps:
preparing an anode slurry from an anode active material and an anode binder at a preset ratio;
applying the anode slurry to an anode current collector 1 to form an anode active material layer 2, thus obtaining an anode electrode plate 5;
forming a recessed portion 23 in the anode active material layer 2, where the anode active material layer 2 has a first surface 21 facing away from the anode current collector 1, and the recessed portion 23 is recessed from the first surface 21 towards the anode current collector 1;
disposing a lithium supplementing material on the first surface 21;
assembling the anode electrode plate 5, the separator 9, and the cathode electrode plate 6 into an electrode assembly 10;
assembling the electrode assembly 10 to obtain a secondary battery; and
performing formation process in the secondary battery.

Through the above method for preparing a secondary battery, a secondary battery including an anode electrode plate 5 that is pre-lithiated and has a recessed portion 23 can be obtained. The secondary battery not only can reduce the impedance of the electrode plate and has good discharge performance, but also can shorten the processing time, helping to improve the processing efficiency.

In some embodiments, the lithium supplementing material is lithium foil, and the lithium foil is disposed on the first surface and rolled. This helps to improve the manufacturing efficiency of the lithium supplementing process and reduce the side reactions between the lithium supplementing material and environmental factors during the lithium supplementing.

In some embodiments, the recessed portion is formed in the anode active material layer through a laser processing process. The energy provided by laser can be used to remove the anode active material and binder of the anode active material layer and has a small impact on the material accumulation state of the anode active material layer.

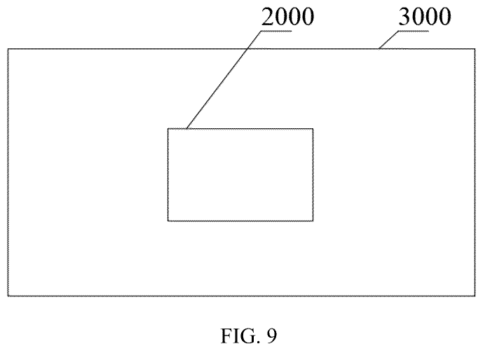

As shown in FIG. 9, an embodiment of this application provides an electronic device 3000 using a secondary battery 2000 as a power source. The electronic device 3000 may be a mobile phone, a portable device, a laptop computer, an electric toy, an electric tool, and the like. The electric tool includes a metal cutting electric tool or a cleaning tool such as an electric drill, an electric wrench, a vacuum cleaner, or a sweeping robot. The electronic device 3000 is not particularly limited in some embodiments of this application.

Although this application has been described with reference to the preferred embodiments, various modifications to this application and replacements of the components therein with equivalents can be made without departing from the scope of this application. In particular, as long as there is no structural conflict, the various technical features mentioned in the implementations can be combined in any manners. This application is not limited to the specific embodiments disclosed in this specification but includes all technical solutions falling within the scope of the claims.

What is claimed is:

1. A secondary battery, comprising an electrode assembly, wherein the electrode assembly comprises an anode electrode plate, the anode electrode plate comprises an anode current collector and an anode active material layer provided on the anode current collector, and the anode active material layer comprises an anode active material; wherein,
the anode active material layer has a first surface facing away from the anode current collector, the anode active material layer is provided with a recessed portion recessed from the first surface towards the anode current collector;
the anode active material layer has a stripe portion exposed from the first surface;
a width of the stripe portion is 0.1 mm to 2.0 mm, and/or, a thickness of the stripe portion is 0.04 μm to 0.50 μm; and
the first surface has been subjected to a lithium supplementing process treatment.

2. The secondary battery according to claim 1, wherein, the recessed portion comprises a hole and/or a groove; and/or
a cross section of the recessed portion is V-shaped; and/or
an edge portion of the recessed portion protrudes out of the first surface by a height h μm, and 3≤h≤10; and/or
the anode active material comprises one or more selected from the group consisting of a carbon material, a silicon material-and a tin material; and/or
the electrode assembly further comprises a cathode electrode plate and a separator, the cathode electrode plate, the separator and the anode electrode plate are stacked, and the first surface is in contact with the separator.

3. The secondary battery according to claim 1, wherein, the anode active material layer is provided with a plurality of the recessed portions, a radius of at least one of the plurality of the recessed portions is R μm, a depth of at least one of the plurality of the recessed portions is H μm, a distance between two adjacent recessed portions is L μm, A=L/(R×H), and 0.20≤A≤5.00.

4. The secondary battery according to claim 3, wherein, 0.20≤A≤3.50.

5. The secondary battery according to claim 1, wherein, a radius of the recessed portion is R μm, and 10≤R≤50.

6. The secondary battery according to claim 5, wherein, 30≤R≤50.

7. The secondary battery according to claim 1, wherein, a depth of the recessed portion is H μm, and 8≤H≤30.

8. The secondary battery according to claim 7, wherein, 15≤H≤30.

9. The secondary battery according to claim 1, wherein, the anode active material layer is provided with a plurality of the recessed portions, a distance between adjacent two of the recessed portions is L μm, and 50≤L≤300.

10. The secondary battery according to claim 9, wherein, 50≤L≤150.

11. The secondary battery according to claim 1, wherein,
the anode active material layer further comprises a lithium compound exposed from the first surface; and
the lithium compound comprises one or more of lithium carbonate or lithium oxide.

12. The secondary battery according to claim 1, wherein, the anode electrode plate further comprises a conductive layer disposed on the first surface, and the conductive layer comprises a conductive agent and a binder.

13. The secondary battery according to claim 12, wherein, a thickness of the conductive layer is B μm, and 0.5≤B≤8.0.

14. The secondary battery according to claim 12, wherein, a porosity of the conductive layer is C, and 30%≤C≤60%.

15. An electronic device, comprising a secondary battery, the secondary battery comprises an electrode assembly, wherein the electrode assembly comprises an anode electrode plate, the anode electrode plate comprises an anode current collector and an anode active material layer provided on the anode current collector, and the anode active material layer comprises an anode active material; wherein,
the anode active material layer has a first surface facing away from the anode current collector, the anode active material layer is provided with a recessed portion recessed from the first surface towards the anode current collector;
the anode active material layer has a stripe portion exposed from the first surface;
a width of the stripe portion is 0.1 mm to 2.0 mm, and/or, a thickness of the stripe portion is 0.04 μm to 0.50 μm; and
the first surface has been subjected to a lithium supplementing process treatment.

16. The electronic device according to claim 15, wherein,
the anode active material layer further comprises a lithium compound exposed from the first surface; and
the lithium compound comprises one or more of lithium carbonate or lithium oxide.

17. A method for preparing the secondary battery of claim 1, the method comprising:
preparing an anode slurry from the anode active material and an anode binder at a preset ratio;
applying the anode slurry to the anode current collector to form the anode active material layer, thus obtaining the anode electrode plate;
forming the recessed portion in the anode active material layer, wherein the anode active material layer has the first surface facing away from the anode current collector, and the recessed portion is recessed from the first surface towards the anode current collector;
disposing a lithium supplementing material on the first surface;
assembling the anode electrode plate into the electrode assembly;
assembling the electrode assembly to obtain the secondary battery; and
performing a formation process in the secondary battery.

18. The method for preparing the secondary battery according to claim 17, wherein, the lithium supplementing material is a lithium foil or a lithium powder.

19. The method for preparing the secondary battery according to claim 18, wherein, the lithium supplementing material is the lithium foil, and the lithium foil is disposed on the first surface and subjected to a rolling process.

20. The method for preparing the secondary battery according to claim 17, wherein, the recessed portion is formed in the anode active material layer through a laser processing process.
